(19) United States
(12) Patent Application Publication
(10) Pub. No.: US 2026/0011801 A1
(43) Pub. Date: Jan. 8, 2026

(54) RECHARGEABLE BATTERY

(71) Applicant: SAMSUNG SDI CO., LTD., Yongin-si (KR)

(72) Inventor: Taejoung KWEON, Yongin-si (KR)

(21) Appl. No.: 19/213,809

(22) Filed: May 20, 2025

(30) Foreign Application Priority Data
Jul. 4, 2024 (KR) 10-2024-0088394

(51) Int. Cl. H01M 10/48; H01M 10/0587; H01M 50/417; H01M 50/46; H01M 50/489

(52) U.S. Cl. CPC H01M 10/488; H01M 10/0587; H01M 50/417; H01M 50/46; H01M 50/489

(57) ABSTRACT

An electrode assembly includes: a separator; first and second electrode plates stacked on each other with the separator therebetween, the first electrode plate having a coated region at where an active material is present and an uncoated region where the active material is not present; a first insulating member having a first color and attached to the uncoated region of the first electrode plate; and a second insulating member having a second color that is different from the first color and attached to the uncoated region of the first electrode plate while at least partially overlapping the first insulating member.

### CROSS-REFERENCE TO RELATED APPLICATION

The present application claims priority to and the benefit of Korean Patent Application No. 10-2024-0088394, filed on Jul. 4, 2024, in the Korean Intellectual Property Office, the entire disclosure of which is incorporated herein by reference.

### BACKGROUND

### 1. Field

Aspects of embodiments of the present disclosure relate to an electrode assembly and a rechargeable battery including the same.

### 2. Description of the Related Art

The capacity of rechargeable batteries embedded in or accommodated in electronic products continues to increase, and the charging voltage and energy density continue to increase, making the safety of the rechargeable batteries increasingly important. Accordingly, the design of an electrode assembly to ensure the safety of the rechargeable batteries is very important.

The rechargeable batteries may not be safety-optimized due to limitations in the manufacturing process, or problems may arise due to dispersion occurring within the electrode assembly after manufacturing.

Conventionally, rechargeable batteries include multiple insulating tapes attached to an uncoated region of each of the positive and negative plates (hereinafter referred to as “electrode plates”) of the electrode assembly to prevent short circuits. The multiple insulating tapes are of the same size and color, made according to unit specifications.

Then, whether or not the electrode plate is insulated by the insulating tape is checked (or determined) by taking a picture of a portion of the electrode plate at where the insulating tape is positioned by using a vision inspection device. However, there are situations where the vision inspection device cannot accurately detect an attachment status of the insulating tape, and a portion of the uncoated region may be exposed to the outside. Accordingly, a short circuit may occur at the electrode plate.

### SUMMARY

Embodiments of the present disclosure provide an electrode assembly and a rechargeable battery including the same exhibiting improved safety.

However, aspects and features of the present disclosure are not limited to those mentioned above, and other aspects and features not mentioned herein would be clearly understood by those skilled in the art from the description and the claims.

According to an embodiment of the present disclosure, an electrode assembly includes: a separator; first and second electrode plates stacked on each other with the separator therebetween, the first electrode plate having a coated region at where an active material is present and an uncoated region where the active material is not present; a first insulating member having a first color and attached to the uncoated region of the first electrode plate; and a second insulating member having a second color that is different from the first color and attached to the uncoated region of the first electrode plate while at least partially overlapping the first insulating member.

Each of the first insulating member and the second insulating member may be attached to a same surface of the first electrode plate.

The first insulating member and the second insulating member may be attached to different surfaces of the first electrode plate.

Each of the first insulating member and the second insulating member may have an insulating portion including an insulating material and an adhesive portion on a first surface of the insulating portion and attached to the first electrode plate.

An adhesion strength of the adhesive portion may be in a range of 350 gf/25 mm to 500 gf/25 mm.

The insulating portion may include a polyethylene resin or a polypropylene resin.

Each of the first insulating member and the second insulating member may have a protrusion protruding from a surface of the adhesive portion attached to the first electrode plate.

A thickness of each of the first insulating member and the second insulating member may be in a range of 18 μm to 36 μm.

The first color and the second color may be complementary colors.

The first color may be red, and the second color may be green.

The first electrode plate may be a positive electrode plate, and the second electrode plate may be a negative electrode plate, or vice versa.

According to another embodiment of the present disclosure, a rechargeable battery includes an electrode assembly as described above and a case accommodating the electrode assembly.

An electrode assembly, according to embodiments of the present disclosure, may be formed by attaching a first insulating member and a second insulating member, which have different colors from each other, to an uncoated region of an electrode plate such that the first and second insulating members at least partially overlap each other. Therefore, a vision inspection device may accurately inspect whether or not the electrode plate is defective by checking for the color of the overlapping region of the first and second insulating members.

Furthermore, the electrode assembly, according to embodiments of the present disclosure, may suppress generation of bubbles. Therefore, the manufacturing quality of rechargeable batteries may be improved.

### BRIEF DESCRIPTION OF THE DRAWINGS

FIG. 1 is an exploded perspective view of a rechargeable battery including an electrode assembly and a case according to an embodiment of the present disclosure.

FIG. 2 is an exploded perspective view of a portion of an electrode assembly according to an embodiment of the present disclosure.

FIG. 3 illustrates a process in which a first insulating member and a second insulating member are attached to a same surface of an uncoated region of an electrode plate.

FIG. 4 is a front view showing a state in which the first insulating member and the second insulating member are attached to the uncoated region of the electrode plate illustrated in FIG. 3.

FIG. 5 illustrates a process in which a first insulating member and a second insulating member are attached to different surfaces of the uncoated region of an electrode plate.

FIG. 6 is a front view showing a state in which the first insulating member is attached to an uncoated region of the electrode plate illustrated in FIG. 5.

FIG. 7 is a front view showing a state in which the second insulating member is attached to an uncoated region of the electrode plate illustrated in FIG. 6.

FIG. 8 is a cross-sectional view of a first insulating member.

FIGS. 9A to 9C are photographs showing results of attachment experiments of an electrode plate, an electrode plate, and an electrode plate, respectively.

FIGS. 10D to 10F are photographs showing results of attachment experiments of an electrode plate, an electrode plate, and an electrode plate, respectively.

FIG. 11 is a cross-sectional view of a first insulating member according to another embodiment.

### DETAILED DESCRIPTION

Embodiments of the present disclosure are provided to more completely explain aspects and features of the present disclosure to those skilled in the art, and the following embodiments may be modified in various different forms. Therefore, the scope of the present disclosure is not limited to the following embodiments. Rather, these embodiments are provided for this disclosure to be thorough and complete and to fully convey the spirit of the disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Before describing an electrode assembly according to an embodiment of the present disclosure, a rechargeable battery to which the electrode assembly according to an embodiment of the present disclosure may be applied will be described in detail.

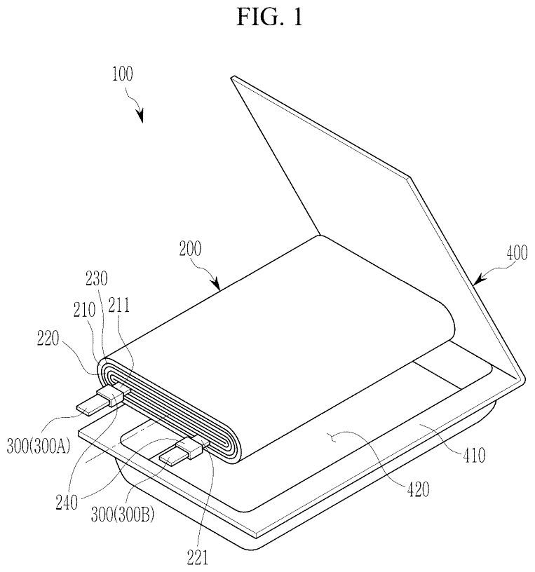

FIG. 1 is an exploded perspective view of a rechargeable battery including an electrode assembly and a case according to an embodiment of the present disclosure.

Referring to FIG. 1, a rechargeable battery 100 may include an electrode assembly 200, an electrode lead 300, and a case 400.

The electrode assembly 200 may include a plurality of electrode plates 210 and 220 and a separator 230. The electrode plates 210 and 220 may include a first electrode plate 210 and a second electrode plate 220.

This electrode assembly 200 may be in a form of a stack including the first electrode plate 210, the second electrode plate 220, and a separator 230 that are wound together or repeatedly stacked on each other.

For example, the electrode assembly 200 may be a stack type in which the electrode plates 210 and 220 are stacked in multiple layers. In another embodiment, the electrode assembly 200 may be a repeatedly wound jelly-roll type.

The jelly-roll type (or wound) electrode assembly may include one (e.g., only one) first electrode plate 210 and one (e.g., only one) second electrode plate 220. The jelly roll type electrode assembly 200 may be manufactured in a manner in which the first electrode plate 210, the separator 230, and the second electrode plate 220 are stacked on each other and then wound on (or wound around) two winding beams.

In the present disclosure, the electrode assembly 200 will be described as being a jelly-roll type as an example, but the present disclosure is not limited thereto.

The separator 230 may be provided between the first electrode plate 210 and the second electrode plate 220. The separator 230 prevents short-circuiting between the first electrode plate 210 and the second electrode plate 220 while enabling (or allowing) the movement of lithium ions. To this end, the separator 230 may be formed to be relatively larger size than the first electrode plate 210 and/or the second electrode plate 220.

A material of the separator 230 may be, for example, polyethylene, polypropylene, or a composite film of polyethylene and polypropylene, but the present disclosure is not limited thereto.

This separator 230 may be installed to be wound between the first electrode plate 210 and the second electrode plate 220. In another embodiment, when the electrode plates 210 and 220 are stacked (or are in stacked arrangement), the separator 230 may be cut into unit lengths and positioned (or arranged) between the first electrode plate 210 and the second electrode plate 220, or a single separator 230 formed in a ribbon (or strip) shape may be positioned in a zigzag configuration between the first electrode plate 210 and the second electrode plate 220. A disposition form or arrangement of the separator 230 is not limited herein.

The electrode assembly 200 as described above may include electrode tabs 211 and 221. The electrode tabs 211 and 221 may extend from the first electrode plate 210 and the second electrode plate 220, respectively. An electrode tab extending from the first electrode plate 210 may be the first electrode tab 211, and an electrode tab extending from the second electrode plate 220 may be the second electrode tab 221.

The electrode lead 300 may be connected to the electrode tabs 211 and 221. The electrode lead 300 may include two electrode leads 300A and 300B. A first electrode lead 300A may be connected to the first electrode tab 211, and a second electrode lead 300B may be connected to the second electrode tab 221, or vice versa. For example, the first electrode plate 210 and the second electrode plate 220 may be electrically connected to outside of the rechargeable battery 100 (e.g., to an external circuit or device) through the electrode lead 300.

A protective member 240 may wrap a portion of the electrode lead 300 corresponding to (e.g., at where the electrode lead 300 exits) the case 400. The protective member 240 may prevent the electrode lead 300 and the case 400 from being electrically connected.

The case 400 may accommodate the electrode assembly 200. The electrode assembly 200 may be accommodated in the case 400 together with an electrolyte.

The case 400 may be any one of a pouch type, a cylindrical type, and a square type. A pouch-like case 400 may be manufactured by bending plate-shaped outer materials such that they face each other and then pressing or drawing one surface to form a recess in one surface.

The electrode assembly 200 is accommodated in a recess 420. A sealing portion 410 may be provided on an outer periphery of the recess, and the sealing portion 410 may be sealed by a method such as heat fusion while the electrode assembly 200 is accommodated in the recess 420.

The electrode plates 210 and 220 may include a positive electrode plate and a negative electrode plate. The first electrode plate 210 may be the negative electrode plate, and the second electrode plate 220 may be the positive electrode plate, or vice versa.

The electrode tabs 211 and 221 may include a positive electrode tab 221 and a negative electrode tab 211. The negative electrode tab 211 may extend from the first electrode plate 210, and the positive electrode tab 221 may extend from the second electrode plate 220.

Hereinafter, the electrode assembly 200 that can be used in the rechargeable (or secondary) battery 100 as described above will be described with reference to the drawings.

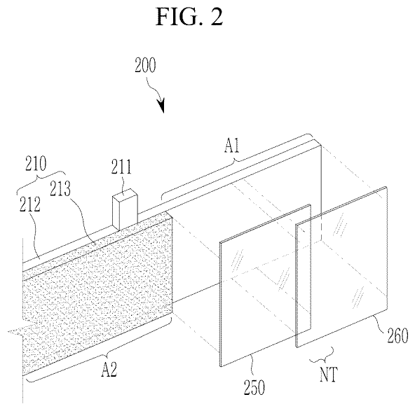

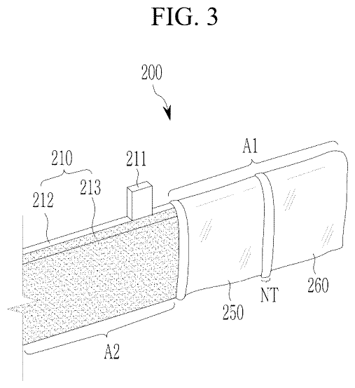

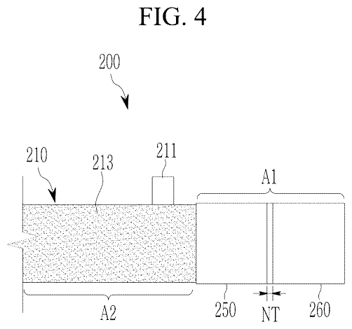

FIG. 2 is an exploded perspective view of a portion of an electrode assembly according to an embodiment of the present disclosure, FIG. 3 illustrates a process in which a first insulating member and a second insulating member are attached to a same surface of an uncoated region of an electrode plate, and FIG. 4 is a front view showing a state in which the first insulating member and the second insulating member are attached to the uncoated region of the electrode plate illustrated in FIG. 3.

Referring to FIGS. 2 to 4, the electrode assembly 200, according to an embodiment of the present disclosure, may include a separator 230 (see, e.g., FIG. 1), an electrode plate 210, a first insulating member 250, and a second insulating member 260.

The separator 230 has been described above, so a detailed description thereof will be omitted.

The electrode plate 210 has been described in detail above but will be described in more detail below. The electrode plate 210 may include a current collecting layer (or current collecting film) 212 and an active material layer 213 on at least a portion of the current collecting layer 212. When dividing the electrode plate 210 by region, the electrode plate 210 may have (or may be divided into) a coated region A2 at where the active material layer 213 is present and an uncoated region A1 at where no active material layer 213 is present. As described above, the electrode plate 210 may include (or may represent) a first electrode plate 210 and a second electrode plate 220.

A method for positioning or forming an active material layer on a current collecting layer may include, for example, a method of discharging slurry on a current collecting layer by using a slit coater and then sequentially performing a magnetization process by using a permanent magnet and a drying process by using a heater.

Another method of positioning or forming the active material layer on the current collecting layer may include a method of attaching a film-shaped active material layer to the current collecting layer. In such an embodiment, the active material layer may be, for example, a dry active material film. A method for manufacturing a dry active material film may include, for example, a method of manufacturing the dry active material film by mixing a binder and an active material, heating (e.g., melting) and stirring it in a twin-screw stirrer, and then extruding the same through a nozzle, but the present disclosure is not limited thereto.

The uncoated region A1 may be positioned at an innermost end of the first electrode plate 210 of the electrode assembly 200 and may be positioned at an outermost end of the second electrode plate 220 of the electrode assembly 200. In another embodiment, the uncoated region A1 may be positioned only at an end portion of either the first electrode plate 210 or the second electrode plate 220. The uncoated region A1 may be positioned in various positions or areas depending on a design of the electrode assembly 200 such that the position of the uncoated region A1 is not limited herein.

For ease of description, the following will be described assuming that the first insulating member 250 and the second insulating member 260, to be described in more detail later, are attached to the uncoated region A1 at an end portion of the first electrode plate 210.

The coated region A1 is a portion at where the active material layer 213 is not coated (or is not present) and the current collecting layer 212 is exposed so that the current collecting layer 212 may be insulated by the first insulating member 250 and the second insulating member 260.

The first insulating member 250 may have a first color and may be attached to the uncoated region A1 of the electrode plate 210 at where there is no active material layer 213.

The second insulating member 260 may have a second color that is different from the first color, is attached to the uncoated region A1 of the electrode plate 210 at where there is no active material layer 213, and may be positioned to overlap at least a portion of (e.g., to at least partially overlap) the first insulating member 250.

The first color and the second color may be complementary colors. For example, the first color may be red, and the second color may be green. Furthermore, the first insulating member 250 and the second insulating member 260 may be made of a translucent material.

Accordingly, when the first insulating member 250 and the second insulating member 260 are attached to the uncoated region A1 of the electrode plate 210 such that a portion thereof overlaps with each other, a color of a portion (e.g., an overlapping portion) NT at where the first insulating member 250 and the second insulating member 260 overlap each other is expressed differently from the first color and the second color.

Accordingly, it may be determined whether or not the electrode plate 210 including the first insulating member 250 and the second insulating member 260 described above was normally manufactured (or normally placed) by a general vision inspection device.

For example, both the first insulating member 250 and the second insulating member 260 are normally attached to target positions in the uncoated region A1 of the electrode plate 210. The vision inspection device may accurately detect the color of the portion NT at where the first insulating member 250 and the second insulating member 260 overlap each other and may determine that the electrode plate 210 has been manufactured normally.

However, if one of the first insulating member 250 and the second insulating member 260 is attached to a position other than the target position of the uncoated region A1 of the electrode plate 210 and the first insulating member 250 and the second insulating member 260 do not overlap each other, the uncoated region A1 is at least partially exposed. In this case, the vision inspection device will not detect the color of the overlapping portion of the first insulation member 250 and the second insulation member 260 and may process (or determine) the electrode plate 210 as a defective product.

As described above, in the electrode assembly 200 according to an embodiment, the first insulating member 250 and the second insulating member 260 having different colors may be attached to the uncoated region A1 in an overlapping manner. Accordingly, the vision inspection device may accurately inspect whether or not the electrode plate 210 is defective.

As described above, the first insulating member 250 and the second insulating member 260 may each be attached to a same surface of the electrode plate 210.

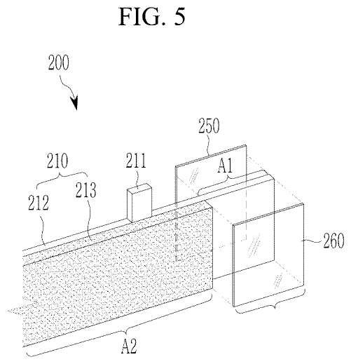

In another embodiment, as shown in FIG. 5, the first insulating member 250 and the second insulating member 260 may each be attached to different surfaces of the electrode plate 210.

A process of attaching each of the first insulating member 250 and the second insulating member 260 to the electrode plate 210 will be described.

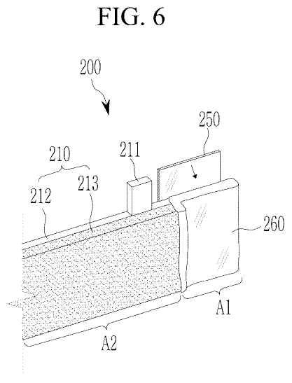

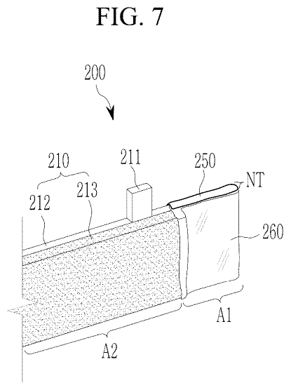

As shown in FIG. 6, the second insulating member 260 may be attached to a first surface of the electrode plate 210. Next, as shown in FIG. 7, the first insulating member 250 may be attached to a second surface of the electrode plate 210. In this embodiment, the first insulating member 250 may be attached to the electrode plate 210 such that a portion NT overlaps the second insulating member 260 (e.g., may overlap each other at a top edge of the uncoated region A1). This is because, as described above, the vision inspection device may quickly check whether or not there is a defect in the electrode plate 210 by photographing the portion NT at where the first insulating member 250 and the second insulating member 260 overlap each other.

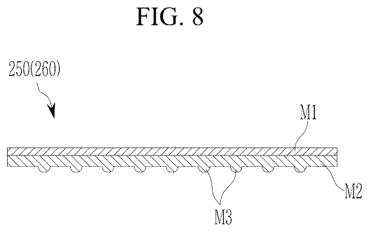

FIG. 8 is a cross-sectional view of a first insulating member. Herein, FIG. 8 may also be a cross-sectional view of the second insulating member.

Referring to FIG. 8, each of the first insulating member 250 and the second insulating member 260 may have an insulating portion M1 and an adhesive portion M2.

The insulating portion M1 may be made of an insulating material. The insulating portion M1 may be any one selected from a polyethylene resin and a polypropylene resin. The insulating portion M1 may be an insulating film.

The adhesive portion M2 may be positioned on a first surface of the insulating portion M1 and may be attached to the electrode plate 210. An adhesion strength of the adhesive portion M2 may be in a range of about 350 gf/25 mm to about 500 gf/25 mm, and a thickness of each of the first insulating member 250 and the second insulating member 260 may be in a range of about 18 μm to about 36 μm.

The following adhesion experiments testing a manufacturing state of the electrode plate 210 according to the thickness and adhesive strength of an insulating member (e.g., the first insulating member 250 or the second insulating member 260) were conducted. The adhesion experiments were conducted by attaching various insulating members 250 and 260 having different thicknesses and adhesion strengths to the uncoated region A1 (see, e.g., FIG. 5) and then checking whether or not bubbles were generated.

TABLE 1

| | Thickness of first | Adhesion strength of | |
|---|---|---|---|
| | insulating member | adhesive portion | |
| Division | (μm) | (gf/25 mm) | Remarks |
| Electrode | 18 | 350 | No bubbles |
| plate A | | | |
| Electrode | 24 | 450 | No bubbles |
| plate B | | | |
| Electrode | 36 | 450 | No bubbles |
| plate C | | | |
| Electrode | 36 | 550 | Bubble |
| plate D | | | generation |
| Electrode | 45 | 350 | Bubble |
| plate E | | | generation |
| Electrode | 45 | 550 | Bubble |
| plate F | | | generation |

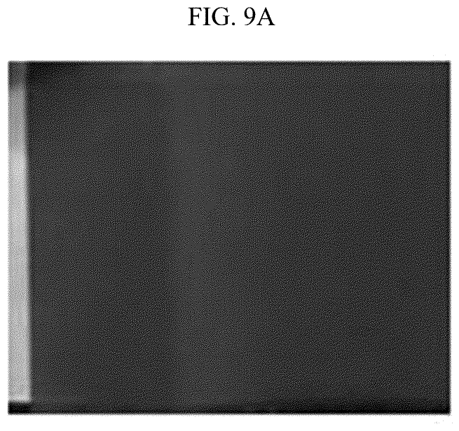

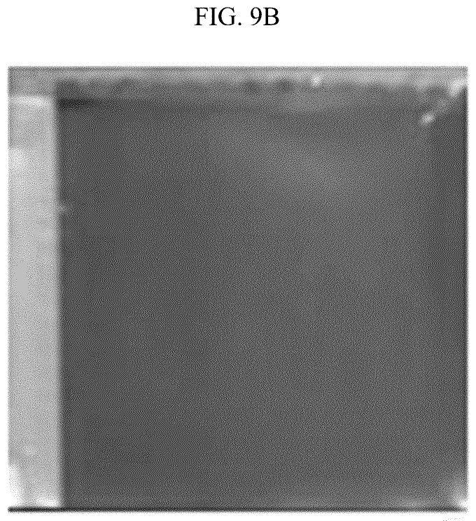

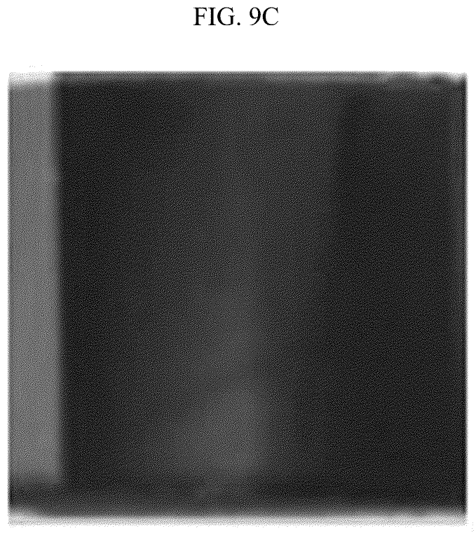

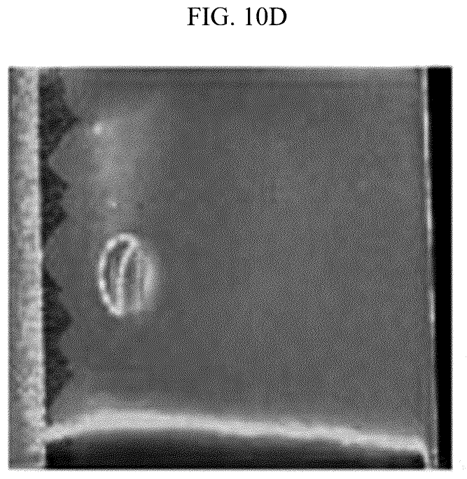

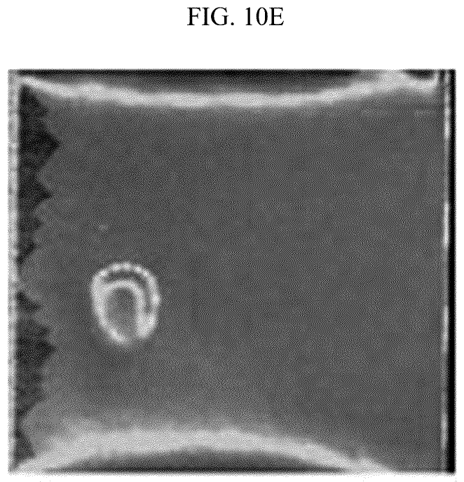

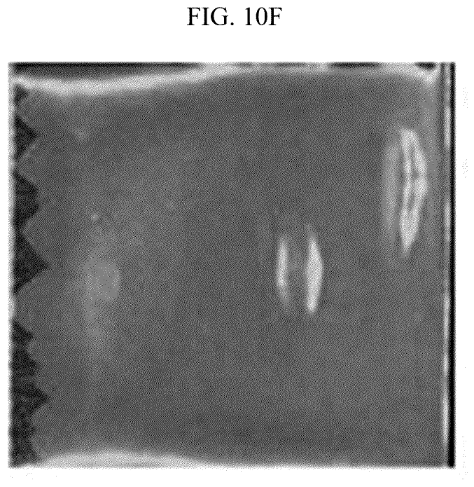

FIGS. 9A to 9C are photographs showing results of attachment experiments of an electrode plate A, an electrode plate B, and an electrode plate C, respectively, and FIGS. 10D to 10F are photographs showing results of attachment experiments of an electrode plate D, an electrode plate E, and an electrode plate F, respectively.

Herein, FIG. 9A is a photograph of the electrode plate A, FIG. 9B is a photograph of the electrode plate B, and FIG. 9C is a photograph of the electrode plate C. Furthermore, FIG. 10D is a photograph of the electrode plate D, FIG. 10E is a photograph of the electrode plate E, and FIG. 10F is a photograph of the electrode plate F.

In Table 1, and referring to FIGS. 9A to 9C and FIGS. 10D to 10F, no bubbles were generated in the electrode plate A to the electrode plate C. However, bubbles occurred in the electrode plate D to the electrode plate F.

Herein, results of the adhesion experiments of the electrode plate C and the electrode plate D confirmed that when the adhesion strength is too high, air bubbles are generated inside the insulating material. Furthermore, results of the attachment experiments of the electrode plate A and the electrode plate E indicate that when a thickness of the insulating material is too thick, air bubbles are generated inside the insulating material. Furthermore, an increase in the thickness of the insulating material may also affect an increase in a thickness of the electrode assembly.

As described above, the electrode assembly according to an embodiment of the present disclosure may prevent bubbles from forming in a manufactured electrode plate by limiting the thickness and the adhesive strength of the adhesive portion of each of the first insulating member and the second insulating member to the aforementioned values.

Referring again to FIG. 8, each of the first insulating member 250 and the second insulating member 260 may have a protrusion M3.

The protrusion M3 may protrude from the surface attached to (or to be attached to) the electrode plate 210 (see, e.g., FIG. 5) and from the adhesive portion M2. The protrusion M3 may suppress generation of bubbles during the process of attaching the first insulating member 250 and the second insulating member 260 to the electrode plate 210 (see, e.g., FIG. 5). A shape of the protrusion M3 may be a hemispherical shape. Hemispherical protrusions M3 may be spaced apart from each other.

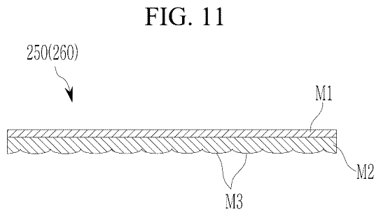

FIG. 11 is a cross-sectional view of a first insulating member according to another embodiment.

Referring to FIG. 11, the protrusions M3 are positioned to be in close contact with each other. The size, position, and arrangement pattern of the protrusions M3 may be variously selected depending on a design of the first insulating member (and may be the same for the second insulating member).

Although several embodiments of the present disclosure have been described above and shown and described with reference to the accompanying drawings, the specific terms used herein are for describing the present disclosure and are not intended to define the meanings thereof or to limit the scope of the present disclosure set forth in the claims and their equivalents. Therefore, a person of ordinary skill in the art will understand that various modifications and other equivalent embodiments of the present disclosure are possible. The technical protective scope of the present disclosure must be determined based on the technical spirit of the appended claims and their equivalents.

### DESCRIPTION OF SOME REFERENCE SYMBOLS

| | |
|---|---|
| 100: rechargeable battery | 200: electrode assembly |
| 210: first electrode plate | 220: second electrode plate |
| 230: separator | 240: protective member |
| 250: first insulating member | 260: second insulating member |
| 400: case | M1: insulating portion |
| M2: adhesive portion | M3: protrusion |
| A1: uncoated region | A2: coated region |

What is claimed is:

1. An electrode assembly comprising:
a separator;
first and second electrode plates stacked on each other with the separator therebetween, the first electrode plate having a coated region at where an active material is present and an uncoated region where the active material is not present;
a first insulating member having a first color and attached to the uncoated region of the first electrode plate; and
a second insulating member having a second color that is different from the first color and attached to the uncoated region of the first electrode plate while at least partially overlapping the first insulating member.

2. The electrode assembly as claimed in claim 1, wherein each of the first insulating member and the second insulating member is attached to a same surface of the first electrode plate.

3. The electrode assembly as claimed in claim 1, wherein the first insulating member and the second insulating member are attached to different surfaces of the first electrode plate.

4. The electrode assembly as claimed in claim 1, wherein each of the first insulating member and the second insulating member has:
an insulating portion comprising an insulating material; and
an adhesive portion on a first surface of the insulating portion and attached to the first electrode plate.

5. The electrode assembly as claimed in claim 4, wherein an adhesion strength of the adhesive portion is in a range of 350 gf/25 mm to 500 gf/25 mm.

6. The electrode assembly as claimed in claim 4, wherein the insulating portion comprises a polyethylene resin or a polypropylene resin.

7. The electrode assembly as claimed in claim 4, wherein each of the first insulating member and the second insulating member has a protrusion protruding from a surface of the adhesive portion attached to the first electrode plate.

8. The electrode assembly as claimed in claim 1, wherein a thickness of each of the first insulating member and the second insulating member is in a range of 18 μm to 36 μm.

9. The electrode assembly as claimed in claim 1, wherein the first color and the second color are complementary colors.

10. The electrode assembly as claimed in claim 1, wherein the first color is red, and the second color is green.

11. The electrode assembly as claimed in claim 1, wherein the first electrode plate is a positive electrode plate, and the second electrode plate is a negative electrode plate.

12. The electrode assembly as claimed in claim 1, wherein the first electrode plate is a negative electrode plate, and the second electrode plate is a positive electrode plate.

13. A rechargeable battery comprising:
the electrode assembly as claimed in claim 1; and
a case accommodating the electrode assembly.
